(19) United States
(12) Patent Application Publication
(10) Pub. No.: US 2012/0173008 A1
(43) Pub. Date: Jul. 5, 2012

(54) METHOD AND DEVICE FOR PROCESSING AUDIO DATA

(75) Inventors: Gang Wang, Shanghai (CN); Jian Zhang, Shanghai (CN)

(73) Assignee: KONINKLIJKE PHILIPS ELECTRONICS N.V., EINDHOVEN (NL)

(21) Appl. No.: 13/395,900

(22) PCT Filed: Sep. 17, 2010
(86) PCT No.: PCT/IB10/54200

§ 371 Date: Mar. 14, 2012

(30) Foreign Application Priority Data
Sep. 21, 2009 (CN) 200910176276.4

(51) Int. Cl. G06F 17/00

(52) U.S. Cl. 700/94

(57) ABSTRACT

To allow users to share visual effects associated with music, the invention provides devices and methods for processing audio data. In an embodiment, a device (3) for providing visual effects is proposed, which comprises a first unit (31) for obtaining information defining a visual effect associated with the audio data, and a second unit (32) for combining the information with audio data to generate a combined data. In another embodiment, a device for extracting visual effects is proposed, comprising: an interface (50) for receiving the combined data and a first unit (51) for extracting the information defining visual effects from the combined data. Users could share their visual effects by communicating the audio data, since the information defining the visual effects is combined with the audio data.

### TECHNICAL FIELD

The present invention relates to signal processing, particularly audio data processing.

### BACKGROUND

In the past, people enjoyed music only in an acoustic way. In recent years, evidence has shown that the influence of visual effects on people is able to improve their appreciation of listening to music. Thus, the visual effects are important. These visual effects are associated, at least in part, with the characteristics of the music such as loudness, frequency and tempo. For example, when music is being played, music players such as the Windows Media Player of Microsoft could display for the user effects such as waveforms, fireworks, or moving curves according to the tempo of the music.

Technologies enabling visual effects to be presented to persons listening to music are known already. For example, FIG. 1 shows a music-based light effects generation system 1, which creates light effects dependent on the music being played. The input of the system 1 is provided by the music source 10. For example, the music source 10 is a MP3 player which outputs analog audio signals for the system 1 via its earphone socket; alternatively, the music source 10 is one track of a music CD, which is read by the system 1 by means of a CD-ROM driver and provides digital signals. Firstly, a music characteristics analyzer 11 loads and analyzes the analog or digital music signals, and obtains music characteristics such as loudness, frequency, and tempo. Then, two factors of the light effects, i.e., brightness of the light and its way of flickering, are determined by a light effects associating means 12, based on the obtained characteristics; according to pre-defined association rules R of associating music characteristics with light effects, for example a high volume corresponds to a high brightness, and a fast tempo corresponds to a high frequency of flickering. After that, the determined light effects are used by the light effects controller 13 to configure the light effects generator 14, which finally generates the desired light effects. Meanwhile, the sound generator 15 loads the analog or digital music signal from the music source, and plays the music. The generated light effects enhance the user's experience of listening to music. An example of such a music-based light effects generation system is a speaker system 20 with a loudspeaker 201 and a surface emitting component 202, as shown in FIG. 2. With respect to the principle shown in FIG. 1, the MP3 player 21 is the music source. The speaker 201 is the sound generator. A microprocessor inside the speaker system 20 operates as the music characteristics analyzer; the light effects associating means and the light effects controller, and the pre-defined association rules can be stored in a memory and loaded by the microprocessor. The surface emitting component 202 emits light in the determined effects according to the control of the microprocessor.

### SUMMARY OF THE INVENTION

It can be seen that the current music-based light effects generation systems must themselves analyze the music, obtain the characteristics of the music and then determine the brightness and way of flickering according to the obtained characteristics. The light effects cannot be communicated among the users.

To better address this concern, in an embodiment of a first aspect of the invention, a device for processing audio data is provided that comprises a first unit for obtaining information defining a visual effect, said visual effect being associated with characteristics of the audio data; and a second unit for combining said information with said audio data to generate a combined data.

In another embodiment of the first aspect of the invention, a method of processing audio data is provided that comprises the steps of: obtaining information defining a visual effect, said visual effect being associated with characteristics of the audio data; and combining said information with said audio data to generate a combined data.

In an embodiment of a second aspect of the invention, a device for processing audio data is provided that comprises an interface for receiving a combined data, said combined data comprising said audio data and information defining a visual effect, said visual effect being associated with the characteristics of the audio data; and a first unit for extracting said information from said combined data.

In another embodiment of the second aspect of the invention, a method of processing audio data is provided that comprises the steps of: receiving a combined data, said combined data comprising said audio data and information defining a visual effect, said visual effect being associated with the characteristics of the audio data; and extracting said information from said combined data.

Embodiments of the invention also provide a signal and a record carrier on which said signal is recorded. Said signal comprising audio data combined with information defining a visual effect, said visual effect being associated with characteristics of the audio data.

Based on these embodiments of the invention, users could share their visual effects by communicating the audio data, since the information defining the visual effects is combined with the audio data.

Preferably, an embodiment of the invention employs digital watermarking technology to combine the information defining visual effects and the audio data to obtain the combined data, wherein the information is embedded, in the form of the payload of the digital watermark, into the audio data to generate the combined data. Correspondingly, the invention also provides an embodiment which employs digital watermarking technology to extract, from the combined data, the information defining visual effects which is embedded, in the form of the payload of the digital watermark, into the audio data. The digital watermarking technology can conceal the information without damaging the audio data, and therefore the music can be played normally and enjoyed by the users.

Further, the current systems can only determine the brightness of the light and its way of flickering according to the characteristics of the music and the way of expressing visual effects is a little bit tedious. In order to improve the expression of the visual effects, in a preferred embodiment of the invention, the visual effects associated with the characteristics of the audio data further comprise colors of the light.

Moreover, a user's preferred association between light effects and the characteristics of the music varies depending on the user's current mood. And one user's preferred relation might be different from that of any other user. In current systems, however, the association rules of light effects and the characteristics of the music are fixed in advance, thus they cannot be flexibly modified according to the preference of the user. In order to improve the flexibility of the visual effects, in a preferred embodiments of the invention, systems obtain visual effects associated with the characteristics of audio data, based on the user's preferred association, via interfaces such as a user interface or a network interface. This adds user customization support, and enables flexibility of the association between visual effects and characteristics of the audio data.

These and other features of the present invention will be described in detail in the embodiment part.

### BRIEF DESCRIPTION OF THE DRAWINGS

Features, aspects and advantages of the present invention are apparent from and will be further elucidated, by way of example by means of the embodiments described hereinafter and with reference to the drawings in which same or similar reference numerals refer to same or similar steps or means.

In the drawings:

FIG. 1 shows a block diagram of a music-based light effects generation system;

FIG. 2 shows a speaker system with a surface emitting component;

FIG. 3 shows a block diagram of a device for processing music, to generate combined data of music and information defining color effects, according to an embodiment of the invention;

FIG. 4 shows a flowchart of a method of processing music, to generate combined data of music and information defining color effects, according to an embodiment of the invention;

FIG. 5 shows a block diagram of a device for processing music, to extract the information defining color effects from combined data, according to an embodiment of the invention;

FIG. 6 shows a flowchart of a method of processing music, to extract the information defining color effects from combined data, according to another embodiment of the invention;

FIG. 7 shows a data structure of the embedded information defining color effects, according to an embodiment of the invention.

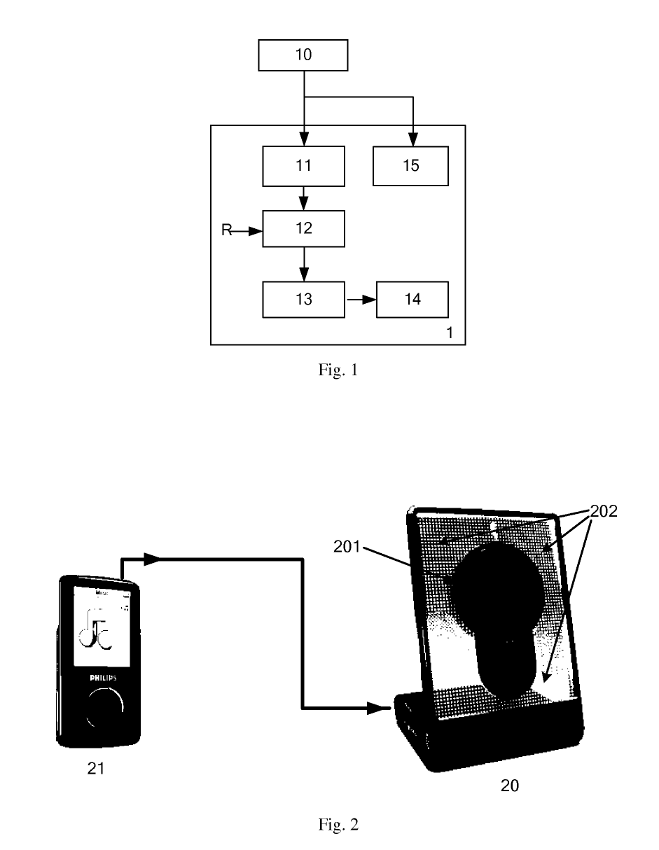

### DETAILED DESCRIPTION OF EMBODIMENTS

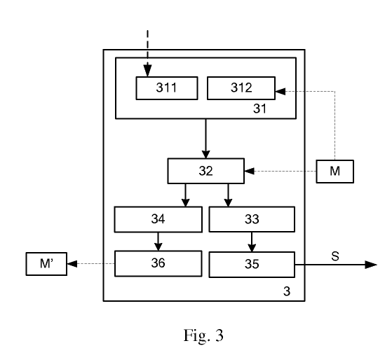

FIG. 3 shows a block diagram of a device 3 for processing audio data, to generate combined data of the audio data and the information defining visual effects. The device 3 comprises a first unit 31, a second unit 32, a converter 33, an audio encoder 34, a third unit 35 and a fourth unit 36. The first unit 31 further comprises an interface 311 and a fifth unit 312. Here, the device 3 is elucidated using functional blocks, while in practice the device 3 may be implemented by way of either software, hardware or a combination thereof. For example, the program codes achieving the functions of the above functional blocks are stored in the memory. These codes are loaded and run by a processor to implement device 3. Alternatively, certain IC chips achieve the functions of the above functional blocks and these chips are controlled by a MCU to implement device 3.

The operation of device 3 and the processing method according to an aspect of the invention will be elucidated with reference to FIG. 4.

First, the user selects the audio data, such as a music file M, to be processed. The music file M is in MP3 format. It should be noted that the invention is not limited to music data in MP3 format but is applicable to any other audio data in any other format, such as music data on CD and voice data.

In step S40, the first unit 31 obtains information defining a visual effect. The visual effect comprises one or more of color, brightness and way of flickering. The color effect is taken as an explanatory example.

Information defining a color effect comprises at least any one of the following:
a specific color;
a range of colors;
a color hint, such as enthusiastic, easy and so on.

In RGB color systems, for example, information defining a color effect comprises: a RGB value (3 components) defining a specific color; a range of RGB values defining a range of colors; and a numeric value defining a color hint.

In an embodiment, in step S401, the interface 311 receives this information defining a visual effect.
In one example, the interface 311 is a user interface. The device 3 decodes the MP3 music file M and plays it through speakers. As the music is being played, the user himself determines the color effect according to his appreciation of the music, and inputs the color effect via the user interface; thus, the user interface receives it. The user interface brings the users lots of freedom to create visual effects. The information defining a color effect could be further uploaded to the network and communicated with other users as an effect file, with indexes of title and length of the music for ease of searching.
In another example, the interface 311 is a network interface. The information defining a color effect might have been created and uploaded to the network by other music fans in the above way, as well as lyric subtitles of songs. The network interface first gets the title and length of the piece of music from the ID3 tag (a metadata container in a MP3 file, which contains basic information of the piece of music such as title, length, artist and album) of the music file M. The network interface then searches the network for a visual effect file containing the information defining the color effect, based on the title and length, and downloads this file. The network interface offers the user much convenience, allowing him to download currently available information defining a visual effect. The user can further preview the visual effect contained in this file on his displayer, and determines whether or not to use it, according to his preference.

This embodiment provides the flexibility to present a proper visual effect according to the user's preferred relation between the visual effects and the music.

In another embodiment, in step S402, the fifth unit 312 analyzes the music data to obtain the characteristics of the music and determines the information defining a color effect according to the analyzing result. This solution is automatic and thus convenient for the users.
In one example, the fifth unit 312 analyzes the music data and obtains characteristics such as loudness, frequency and tempo. And it determines the color effect according to the obtained result based on certain rules, for example fast tempo corresponds to warm colors such as red;
In another example, the fifth unit 312 obtains the style of the music from the ID3 tag of a MP3 file M, such as classical, rock or R&B. It then determines a color hint corresponding to the style according to certain rules, such as easy corresponds to R&B.

The information defining a visual effect determined by the fifth unit 312 can be further previewed and modified by the user according to his preference through the user interface.

In general, the visual effect is associated with characteristics of the audio data in at least any one of the following ways:
the visual effect is determined by the user manually, according to his experience of the characteristics of the music being enjoyed;
the visual effect is determined by the fifth unit 312 automatically, by analyzing and obtaining the characteristics of the music and associating the visual effect based on predefined association rules between the visual effect and the characteristics of the music.

It should be noted that the invention is not limited to the above ways, and any other ways to determine a visual effect according to the music to be played are within the scope of “a visual effect associated with characteristics of music”, and thus fall within the scope of the claims of the invention.

Like a color effect, also a brightness effect and a flickering effect can be determined by the user or by the analysis of the fifth unit 312, and can be recorded for processors. As this is well known to those of skill in the art about how to analyze and associate music with brightness and or flickering effect, it will not be explained in greater detail herein.

After the information is obtained by the first unit 31, in step S41, the second unit 32 combines the information with the music data to generate a combined data.

Specifically, the second unit 32 loads the music file M in MP3 format, decodes the file M and obtains the music data in undecoded format. The music data in undecoded format is a digital format. The second unit 32 combines the information with the music data in undecoded format using digital watermarking technology. Currently, there are many watermarking technologies for embedding the information in music data, either in a time domain (spatial domain) or a transformed domain such as a frequency domain. Usually, these digital watermarking methods can hide the information very welll so that it doesn't damage the music data, and the listener cannot notice the difference between watermarked music and ‘clean’ music without a watermark. For example, when using watermarking in a frequency domain, the information is attached to the frequency components, imperceptible for human beings. The second unit 32 transforms the music data into a frequency domain and gets the frequency representation of the music data. Then the second unit 32 adds the frequency components carrying the information to the frequency representation of the music data and then transforms the frequency representation of the music with the frequency components back to a time domain, thus generating the combined data. The digital watermarking technologies are common knowledge for those of ordinary skill in the art and are described in textbooks such as Digital Watermarking and Steganography, 2nd Ed. by Ingemar Cox et al., Morgan Kaufmann, 2007; thus it will not be explained in greater detail herein. It should be noted that any other technology for combining the information with the music data is also applicable and thus falls within the scope of the claims of the invention.

The format of the embedded information defining a visual effect can be defined as a standard, so that all speaker systems supporting this standard can parse the information and obtain the visual effect. An example of the data structure of a frame is shown in FIG. 7. Therein, a header section H contains the length of the frame. A type section T contains a type value indicating the type of the color effect, for example 1 stands for a specific color, 2 stands for a range of colors, and 3 stands for a color hint. And a value section V contains the information defining the color effect, for example, a RGB value, a range of RGB values, and a numeric value. The frame could also contain a CRC section C with the CRC value of the previous type value and color value, for assisting the speaker systems to check errors of the received type value and color value.

Preferably, but not necessarily, the visual effect may also contain a time effect corresponding to the color effect, indicating when the color effect should be presented during music playback. In this case, the certain color effect can be embedded into a section of the music data, which is a little bit advanced in time when the color effect is to be presented. Right after the speaker system extracts the information, it presents the color effect for the music.

After the combined data is generated, it can be provided to a speaker system to be played, or it can be stored. The stored combined data can be in either encoded format or unencoded format, according to the music quality requirement and the space of the storage means. The invention has the following embodiments according to these different ways of outputting combined data and different formats:

Combined Data is Played

When the combined data is in unencoded format, in one case, the third unit 35 directly outputs the combined data in digital format to digital speaker systems to play music and present a visual effect, via digital interfaces such as S/PDIF connectors. In another case, in step S42, the D/A converter 33 converts the combined data in digital format into an analog format for analog speaker systems. And in step S43, the third unit 35 outputs the combined data S in analog format to analog speaker systems to play music and present a visual effect, via analog interfaces such as the common TRS (Tip, Ring, Sleeve) connectors. In the latter case, since the analog speaker systems would generally convert the combined data S in analog format back to digital format to extract the digitally-embedded information, the digital watermarking technology used to embed the information should be sufficiently robust to resist the distortion resulting from the processes of D/A transformation and A/D transformation.

When the music data in the combined data is in encoded format, the device 3 further comprises an audio decoder. The audio decoder decodes the combined data before the third unit 35 outputs the combined data, or the D/A converter 33 converts the combined data to analog format, in order to provide unencoded data that can be played by the speaker system. It should be understood that the audio decoder can be omitted in the case that the speaker system has an inherent decoding function and is able to decode the encoded combined data provided by the third unit 35.

The above digital and analog speaker systems will be described as “device 5” in the following embodiments.

It should be noted that ordinary speaker systems, without the function of extracting information defining a visual effect and presenting the visual effect, could also play the combined data and play the music, since the embedding of the information doesn't damage the music data.

The above embodiments provide a signal comprising music data combined with information defining a color effect, which is associated with characteristics of the music. The signal is available in either digital format or analog format.

Combined Data is Stored

When the music data in the combined data is in unencoded format, in one case, the fourth unit 36 stores the combined data, for example burns the combined data in a music CD, for later music playback and for presenting a visual effect. In another case, to reduce the size of the combined data and save storage space, in step S42, the audio encoder 34 encodes the combined data using a MP3 codec. And in step S43, the fourth unit 36 stores the encoded combined data for later playback and for presenting a visual effect. For example, the fourth unit 36 writes the encoded combined data as a MP3 file M′ to a hard disk, uploads the encoded combined data as a MP3 file M′ to a network, or broadcasts the media stream of the encoded combined data to other users in the way of an Internet radio station. In this case, since the encoded combined data will be decoded again in order to retrieve the embedded color effect, the digital watermarking technology used to embed the information should possess enough robustness to resist any distortion resulting from the processes of encoding and decoding.

When the music data in the combined data is in encoded format, in one case, the fourth unit 36 directly stores the encoded combined data for later playback and for presenting a visual effect. For example, the fourth unit 36 writes the encoded combined data as a MP3 file M′ to a hard disk, uploads the encoded combined data as a MP3 file M′ to a network, or broadcasts the media stream of the encoded combined data to other users in the way of an Internet radio station. In another case, the device 3 further comprises an audio decoder, which decodes the combined data. And the fourth unit 36 stores the decoded combined data for later music playback and for presenting a visual effect, for example burning the decoded combined data in a music CD.

In the above embodiments, the users can use this device 3 to create music files with their own color-music association and share them with friends. The music company can also use device 3 to publish music with recommended color-music association. The color effect could then be communicated along with the combined data to the users.

The above embodiments provide a record carrier having recorded thereon a signal comprising music combined with information defining a color effect, which is associated with characteristics of the music. The signal could be either in encoded format or unencoded format.

The device and method for processing audio data, to generate a combined data of audio data and information defining a visual effect, have been elucidated hereinabove. A device and method for processing audio data, to extract the information defining a visual effect from a combined data will be elucidated hereinafter.

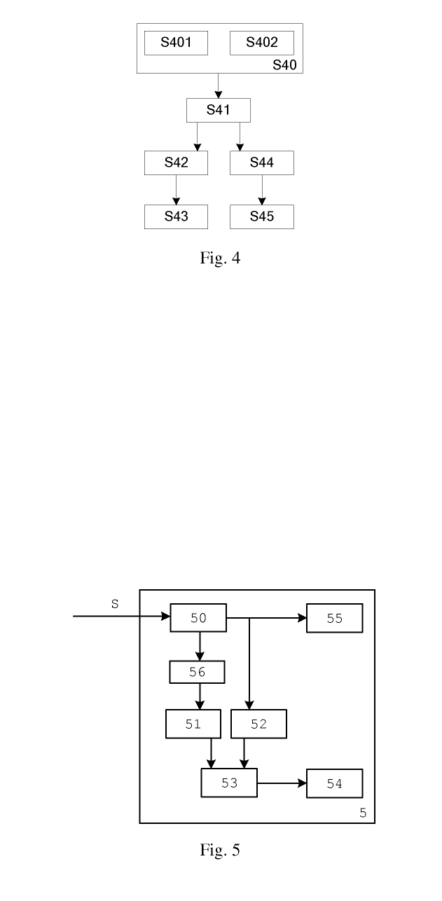

FIG. 5 shows a block diagram of a device 5 for processing audio data to extract the information defining a visual effect from a combined data. The device 5 comprises an interface 50, a first unit 51, a fourth unit 52, a fifth unit 53, a third unit 54, a second unit 55 and an A/D converter 56. The device 5 could be a speaker system. The functional blocks 51, 52, 53 and 54 could be implemented by IC chips controlled by a MCU in the speaker system. It is to be noted that FIG. 5 is the drawing for illustrating many embodiments, although many units has been shown in the FIG. 5, they are not necessary for implementing the invention. Some of the units are not needed for one embodiment, and some other units are not needed for another embodiment. For example, the unit 56 A/D converter is not needed if the combined data are already digital data.

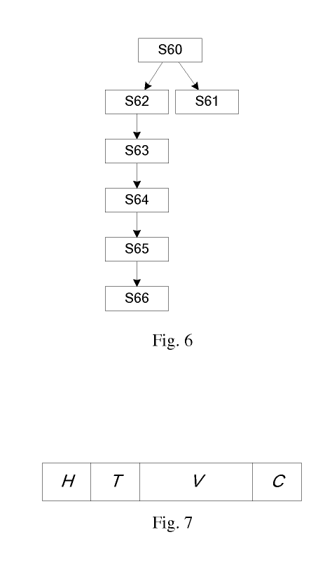

The operation of the device 5 and the processing method according to another embodiment of the invention will be elucidated with reference to FIG. 6. Music data is taken as an example of audio data, but the invention is not limited thereto and other audio data such as voice data fall within the scope of the invention too.

In step S60, the interface 50 receives a combined data S. The combined data S comprises music data and information defining a color effect; and the color effect is associated with the characteristics of the music. Preferably, the information is combined with the music data by digital watermarking technology.

In one case, the combined data S is provided by the above device 3. In another case, any ordinary music player loads a music file M′ of encoded combined data S or receives the media stream of encoded combined data S. The music player decodes the encoded combined data S and sends the combined data to the device 5.

As to the combined data S, since the information defining the visual effect is embedded in a hardly perceptible way, the combined data can be played directly. In step S61, the second unit 55 such as a loudspeaker obtains the combined data from the interface 50 and plays the music. In one embodiment, the device 5 is a digital speaker system and the combined data is in digital format, thus the second unit 55 converts it to analog format, amplifies it and generates sound waves of the music corresponding to the electric signals via an energy exchanger. In another embodiment, the device 5 is an analog speaker system and the combined data is in analog format, thus the second unit 55 directly plays the music by generating sound waves of the music corresponding to the electric signals via an energy exchanger.

Synchronously, as regards the color effect in the combined data S, in one embodiment, the combined data is in digital format and received via S/PDIF connectors. The first unit 51 extracts the information from the combined data. In another embodiment, the combined data is in analog format and received via TRS connectors. In step S62, the A/D converter 56 converts the combined data into digital format. And in step S63, the first unit 51 extracts the information from the combined data in digital format. The digital watermarking technology for extracting the information in a digital watermark from the combined data is common knowledge to those of ordinary skill in the art, thus it will not be explained in greater detail herein.

In an embodiment, the information defining a color effect comprises the RGB value of a specific color. The third unit 54 generates a signal to control the light-emitting component, such as LEDs, according to the RGB value of the specific color, and sends the signals to the LEDs. The LEDs emit lights of the specific color. Alternatively, the information comprises a color hint for example “enthusiastic”. The third unit 54 determines the color corresponding to the hint according to certain rules, for example red and yellow are for “enthusiastic”, and presents the corresponding colors. Take “enthusiastic” for example. The third unit 54 generates signals to control the light-emitting component according to the RGB values of red and yellow, and sends the signals to the light-emitting component. The light-emitting component emits lights in red and yellow.

In another embodiment, in one example, the information comprises the RGB value of a specific color. In step S64, the fourth unit 52 analyzes the combined data, that is to say the fourth unit 52 analyzes the music itself substantially, to obtain the tempo of the music. In step S65, the fifth unit 53 determines an overall visual effect, i.e. that the light in this specific color flickers in a certain way, according to the tempo obtained by the fourth unit 52 and the specific color extracted by the first unit 51. In another example, the information comprises a scope of colors for this music.

In another embodiment, the embedded information defining visual effects should consist of as few bytes as possible, to avoid the influence on the quality of the music. Thus, the information defining a visual effect might contain only information defining a certain color effect, without the information defining brightness and frequency of flickering. In step S64, the fourth unit 52 analyzes the music data in the combined data and obtains the characteristics of the music, such as loudness, frequency and tempo. In step S65, the fifth unit 53 determines an overall visual effect, i.e. that the light of a certain color flickers in the determined way with the determined brightness, according to the tempo and loudness obtained by the fourth unit 52 and the certain color extracted by the first unit 51.

In step S66, the third unit presents the overall visual effect.

In the above embodiments, the combined data S is in unencoded format. In a variant embodiment, the combined data S is encoded. For example, the device 5 loads the file M′ of the encoded combined data S on a USB disk which is plugged in the USB socket of the device 5. The device 5 comprises a decoder to decode the combined data S, and then it carries out a D/A conversion and plays the music. In this embodiment, in one case, the encoded combined data S is obtained by encoding the combined data of information defining a visual effect and unencoded music data; thus, the first unit 51 extracts the information defining a visual effect from the decoded combined data S outputted by the decoder. In another case, the encoded combined data is obtained by combining the information defining a visual effect and encoded music data; thus, the first unit 51 extracts the information defining a visual effect from the combined data S.

When the visual effect contains a time effect, the certain color effect corresponding to the time effect is embedded into a section of music data which is a little bit advanced in time when the color effect is to be presented. Right after that, the first unit 51 extracts the information defining the color effect; and the third unit 54 immediately presents the color effect for the music.

The above embodiments take color as an example of a visual effect to elucidate the invention. It should be noted that the invention is not limited to color. Information defining pattern, variation of color, variation of pattern or any other visible presentation, can be combined with audio data, extracted and presented by other embodiments of the invention. Thus, they are all within the scope of the visual effect, and within the scope of the claims of the invention.

Although the embodiments of the present invention have been explained hereinabove in detail, it should be noted that the above-described embodiments are for the purpose of illustration only, and are not to be construed as a limitation of the invention. The present invention is not limited to these embodiments.

Those of ordinary skill in the art will understand that modifications to the disclosed embodiments are possible and will be able to realize these modifications through studying the description, drawings and appended claims. All such modifications which do not depart from the spirit of the invention are intended to be included within the scope of the appended claims. The word “comprising” does not exclude the presence of elements or steps not listed in a claim or in the description. The word “a” or “an” preceding an element does not exclude the presence of a plurality of such elements. In the practice of the present invention, several technical features in the claim can be embodied by one component. In the claims, any reference signs placed between parentheses shall not be construed as limiting the claim.

1. A device for processing audio data, comprising:
a first unit (31) for obtaining information defining a visual effect, said visual effect being associated with characteristics of the audio data;
a second unit (32) for combining said information with said audio data to generate a combined data.

2. A device according to claim 1, wherein said audio data is in digital format, and said second unit (32) combines said information with said audio data using digital watermarking technology.

3. A device according to claim 1, further comprising at least any one of the following:
a third unit (35) for outputting said combined data;
a fourth unit (36) for storing said combined data.

4. A device according to claim 3, further comprising at least one of the following:
a converter (33) for converting said combined data into analog format, before the combined data is outputted by said third unit (35) or is stored by said fourth unit (36);
an audio encoder (34) for encoding said combined data, before the combined data is outputted by said third unit (35) or is stored by said fourth unit (36), in case said combined data is in unencoded format;
an audio decoder for decoding said combined data, before the combined data is outputted by said third unit (35) or is stored by said fourth unit (36), in case said combined data is in encoded format.

5. A device according to claim 1, wherein said first unit (31) comprises at least any one of the following:
an interface (311) for receiving said information;
a fifth unit (312) for analyzing the audio data to obtain the characteristics of said audio data, and determining said information according to the analyzing result.

6. A device according to claim 1, wherein said visual effect comprises a color effect.

7. A device for processing audio data, comprising:
an interface (50) for receiving a combined data, said combined data comprising said audio data and information defining a visual effect, said visual effect being associated with the characteristics of the audio data;
a first unit (51) for extracting said information from said combined data.

8. A device according to claim 7, wherein said information is combined with said audio data using digital watermarking technology, and said first unit (51) is further used for extracting said information using digital watermarking technology;
when said combined data received by said interface (50) is in analog format, the device further comprises:
a converter (56) for converting said combined data into digital format, before said information is extracted from said combined data by said first unit (51).

9. A device according to claim 7, further comprising:
a second unit (55) for playing said audio data;
a third unit (54) for presenting said visual effect according to said information when said audio data is played.

10. A device according to claim 9, further comprising:
a fourth unit (52) for analyzing the audio data to obtain the characteristics of the audio data;
a fifth unit (53) for determining an overall visual effect according to the analyzing result obtained by the fourth unit (52) and the information extracted by said first unit (51);
wherein said third unit (54) is further used for presenting said overall visual effect.

11. A device according to wherein said visual effect comprises a color effect.

12. A method of processing audio data, comprising the steps of:
obtaining information defining a visual effect, said visual effect being associated with characteristics of the audio data;
combining said information with said audio data to generate a combined data.

13. A method of processing audio data, comprising the steps of:
receiving a combined data, said combined data comprising said audio data and information defining a visual effect, said visual effect being associated with the characteristics of the audio data;
extracting said information from said combined data;
playing said audio data;
presenting said visual effect according to said information when said audio data is played.

14. A signal comprising audio data combined with information defining a visual effect, said visual effect being associated with characteristics of the audio data.

15. A record carrier having recorded thereon a signal as claimed in claim 14.
